(19) United States
(12) Patent Application Publication
(10) Pub. No.: US 2025/0349470 A1
(43) Pub. Date: Nov. 13, 2025

(54) MULTILAYER CERAMIC ELECTRONIC COMPONENT

(71) Applicant: TAIYO YUDEN CO., LTD., Tokyo (JP)

(72) Inventors: Hidetoshi MASUDA, Takasaki-shi (JP); Youichi MIZUNO, Takasaki-shi (JP); Takashi SASAKI, Takasaki-shi (JP); Yusuke KOWASE, Takasaki-shi (JP)

(21) Appl. No.: 19/277,993

(22) Filed: Jul. 23, 2025

Related U.S. Application Data
(63) Continuation of application No. PCT/JP2024/002672, filed on Jan. 29, 2024.

(30) Foreign Application Priority Data
Mar. 7, 2023 (JP) 2023-034358

(51) Int. Cl. H01G 4/30; H01G 4/012

(52) U.S. Cl. CPC H01G 4/30; H01G 4/012

(57) ABSTRACT

A multilayer ceramic electronic component includes a first external electrode provided at an end portion of a ceramic element, and a second external electrode provided at another end portion of the ceramic element. An internal electrode provided in the ceramic element includes a lead internal electrode connected to the first external electrode or the second external electrode, and a first floating electrode facing the lead internal electrode via a dielectric layer in the ceramic element and provided in a state of being separated from the first external electrode and the second external electrode. At least one of the lead-out internal electrode and the first floating electrode includes a first boundary layer in contact with the dielectric layer formed between the lead-out internal electrode and the first floating electrode. The boundary layer contains at least one of Au, Pt, Ag, Fe, Sn, Ge, Hf, In, Si, V, or Y.

### CROSS-REFERENCE TO RELATED APPLICATION

This application is based upon and claims the benefit of priority of the prior International Patent Application No. PCT/JP2024/002672, filed on Jan. 29, 2024, which claims the benefits of priorities of Japanese Patent Application No. 2023-034358 filed on Mar. 7, 2023, the entire contents of which are incorporated herein by reference.

### FIELD

A certain aspect of the present invention relates to a multilayer ceramic electronic component.

### BACKGROUND

A multilayer ceramic capacitor, which is one of multilayer ceramic electronic components, includes a ceramic element in which a plurality of dielectric layers and a plurality of internal electrodes are alternately laminated, and a pair of external electrodes (terminal electrodes) formed on a surface of the multilayer body so as to be electrically connected to the internal electrodes led out to a surface of the multilayer body. Among such multilayer ceramic capacitors, a configuration is also known in which a floating electrode that is not electrically connected to any external electrode is provided in a ceramic element (for example, see Japanese Unexamined Utility Model Application Publication No. S60-76028 and Japanese Unexamined Patent Application Publication No. H07-263269). In Japanese Unexamined Utility Model Application Publication No. S60-76028, the floating electrode is provided for the purpose of improving the withstand voltage of the multilayer ceramic capacitor. In Japanese Unexamined Patent Application Publication No. H07-263269, the floating electrode has a double structure for the purpose of increasing Quality Factor of the multilayer ceramic capacitor.

### SUMMARY OF THE INVENTION

(1) According to an aspect of the present disclosure, there is provided a multilayer ceramic electronic component including: a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction; a first external electrode provided at an end portion of the ceramic element in the third axis direction; and a second external electrode provided at another end portion of the ceramic element in the third axis direction, wherein the internal electrode includes an lead internal electrode connected to the first external electrode or the second external electrode, and a first floating electrode facing the lead internal electrode along the first axis direction via the dielectric layer in the ceramic element and provided in a state of being separated from the first external electrode and the second external electrode, at least one of the lead internal electrode and the first floating electrode includes a first boundary layer in contact with the dielectric layer formed between the lead internal electrode and the first floating electrode, and the first boundary layer includes at least one of Au, Pt, Ag, Fe, Sn, Ge, Hf, In, Si, V, or Y.

(2) In the multilayer ceramic electronic component according to the above (1), the lead internal electrode may include a first lead internal electrode led out to a side of the ceramic element in the third axis direction and connected to the first external electrode, and a second lead internal electrode disposed to be shifted from the first lead internal electrode in the first axis direction, led out to another side of the ceramic element in the third axis direction, and connected to the second external electrode, and the first floating electrode may be provided between the first lead internal electrode and the second lead internal electrode via the dielectric layer in the ceramic element.

(3) In the multilayer ceramic electronic component according to the above (1), the first boundary layer may be provided only on the first floating electrode.

(4) In the multilayer ceramic electronic component according to the above (1), when the second axis direction is defined as a width direction, a width size of the first floating electrode may be larger than a width size of the lead internal electrode.

(5) In the multilayer ceramic electronic component according to the above (1), the first floating electrode may include a pair of side edges extending along the third axis direction, and at least one of the side edges may be located outside the lead internal electrode along the second axis direction.

(6) In the multilayer ceramic electronic component according to the above (1), when the third axis direction is defined as a length direction, a length size of the first floating electrode may be larger than a length size of the lead internal electrode.

(7) In the multilayer ceramic electronic component according to the above (1), an end portion of the first floating electrode in the third axis direction may be located outward in the third axis direction relative to an end portion of the lead internal electrode in the third axis direction, the end portion being opposite to an end portion of the lead internal electrode connected to the first external electrode or the second external electrode.

(8) In the multilayer ceramic electronic component according to the above (1), the internal electrode may include a core material, and the first boundary layer may be formed on at least one side of the core material in a first axis direction.

(9) In the multilayer ceramic electronic component according to the above (1), when the first axial direction is defined as a thickness direction, a thickness size of the first floating electrode may be smaller than a thickness size of the lead internal electrode.

(10) In the multilayer ceramic electronic component according to the above (1), the lead internal electrode may include a third lead internal electrode led out to one side of the ceramic element in the third axis direction and connected to the first external electrode, and a fourth lead internal electrode disposed to be shifted from the third lead internal electrode in the third axis direction, led out to another side of the ceramic element in the third axis direction, and connected to the second external electrode, the internal electrode may include a plurality of the first floating electrodes arranged along the third axis direction so as to be spaced apart from each other, and a second floating electrode arranged between the third lead internal electrode and the fourth lead internal electrode along the third axis direction, one of the plurality of the first floating electrodes may face the third lead internal electrode and the second floating electrode along the first axis direction via the dielectric layer, and another of the plurality of the first floating electrodes may face the fourth lead internal electrode and the second floating electrode along the first axis direction via the dielectric layer.

(11) In the multilayer ceramic electronic component according to the above (10), the second floating electrode may include a second boundary layer formed between the first floating electrode and the second floating electrode and in contact with the dielectric layer, and the second boundary layer may include at least one of Au, Pt, Ag, Fe, Sn, Ge, Hf, In, Si, V, or Y.

(12) In the multilayer ceramic electronic component according to the above (10), the internal electrode may include a core material, and the second boundary layer may be formed on at least one side of the core material in the first axis direction.

(13) In the multilayer ceramic electronic component according to the above (10), when the first axis direction is defined as a thickness direction, a thickness size of the second floating electrode may be smaller than a thickness size of the lead internal electrode.

### BRIEF DESCRIPTION OF THE DRAWINGS

FIG. 1 is a perspective view of a multilayer ceramic capacitor according to an embodiment.

FIG. 2A is a cross-sectional view taken along line A-A in FIG. 1, and FIG. 2B is a cross-sectional view taken along line B-B in FIG. 1.

FIG. 3A is an explanatory view illustrating a first lead internal electrode, a first floating electrode, and a second lead internal electrode in a first embodiment in an enlarged manner, and FIG. 3B is an explanatory view illustrating a variation of the first lead internal electrode, the first floating electrode, and the second lead internal electrode.

FIG. 4 is a cross-sectional view taken along line C-C in FIG. 1.

FIG. 5A is an explanatory view schematically illustrating the first lead internal electrode, the first floating electrode, and the second lead internal electrode in the first embodiment, and FIG. 5B is a circuit diagram approximately illustrating a circuit formed in the multilayer ceramic capacitor according to the first embodiment.

FIG. 6 is a cross-sectional view of a multilayer ceramic capacitor according to a second embodiment taken along a line corresponding to line A-A in FIG. 1.

FIG. 7A is an explanatory view schematically illustrating a first lead internal electrode, a first floating electrode, and a second lead internal electrode in the second embodiment, and FIG. 7B is a circuit diagram approximately illustrating a circuit formed in the multilayer ceramic capacitor according to the second embodiment.

FIG. 8A is a cross-sectional view of the multilayer ceramic capacitor of the third embodiment taken along a line corresponding to line A-A in FIG. 1, and FIG. 8B is a cross-sectional view of the multilayer ceramic capacitor of the third embodiment taken along a line corresponding to line B-B in FIG. 1.

FIG. 9 is a cross-sectional view of a multilayer ceramic capacitor according to a third embodiment taken along a line corresponding to line C-C in FIG. 1.

FIG. 10A is an explanatory view schematically illustrating a third lead internal electrode, a first floating electrode, a second floating electrode, and a fourth lead internal electrode in the third embodiment, and FIG. 10B is a circuit diagram approximately illustrating a circuit provided in the multilayer ceramic capacitor according to the third embodiment.

FIG. 11 is a cross-sectional view of a multilayer ceramic capacitor according to a fourth embodiment taken along a line corresponding to the line A-A in FIG. 1.

FIG. 12A is an explanatory view schematically illustrating a first lead internal electrode, a first floating electrode, a second floating electrode, and a second lead internal electrode in the fourth embodiment, and FIG. 12B is a circuit diagram approximately illustrating a circuit formed in the multilayer ceramic capacitor according to the fourth embodiment.

FIG. 13 is a cross-sectional view of a multilayer ceramic capacitor according to a fifth embodiment taken along a line corresponding to line A-A in FIG. 1.

FIG. 14 is a cross-sectional view of a multilayer ceramic capacitor according to a sixth embodiment taken along a line corresponding to line A-A in FIG. 1.

### DETAILED DESCRIPTION

In order to improve the reliability of a multilayer ceramic electronic component, it is effective to improve the withstand voltage. For example, the configuration disclosed in Japanese Unexamined Utility Model Application Publication No. S60-76028 is considered to be capable of improving the withstand voltage, but there is room for improvement from the viewpoint of more effectively improving the withstand voltage.

An object of the present disclosure is to provide a multilayer ceramic electronic component with improved withstand voltage.

Hereinafter, a multilayer ceramic capacitor 1 according to an embodiment of the present disclosure will be described with reference to the accompanying drawings. In the drawings, the dimensions, ratios, and the like of the respective parts may not be illustrated so as to completely match the actual ones. For convenience of drawing, details may be omitted or components themselves may be omitted depending on the drawings. In the drawings, an X-axis, a Y-axis, and a Z-axis orthogonal to each other are illustrated as appropriate. In the following description, a Z-axis direction corresponds to a first axis direction, and a Y-axis direction corresponds to a second axis direction. An X-axis direction corresponds to a third axis direction.

### First Embodiment

### [Structure of Multilayer Ceramic Capacitor]

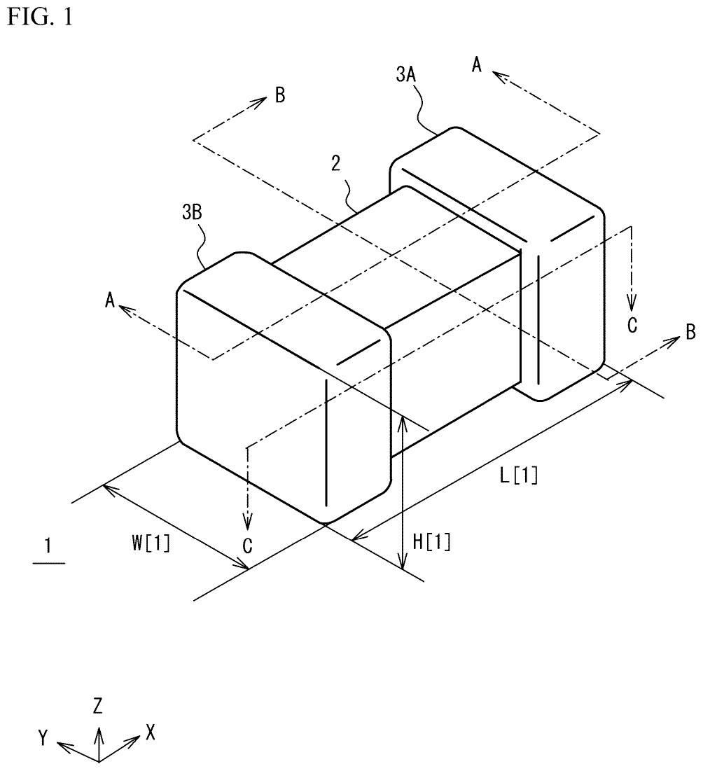

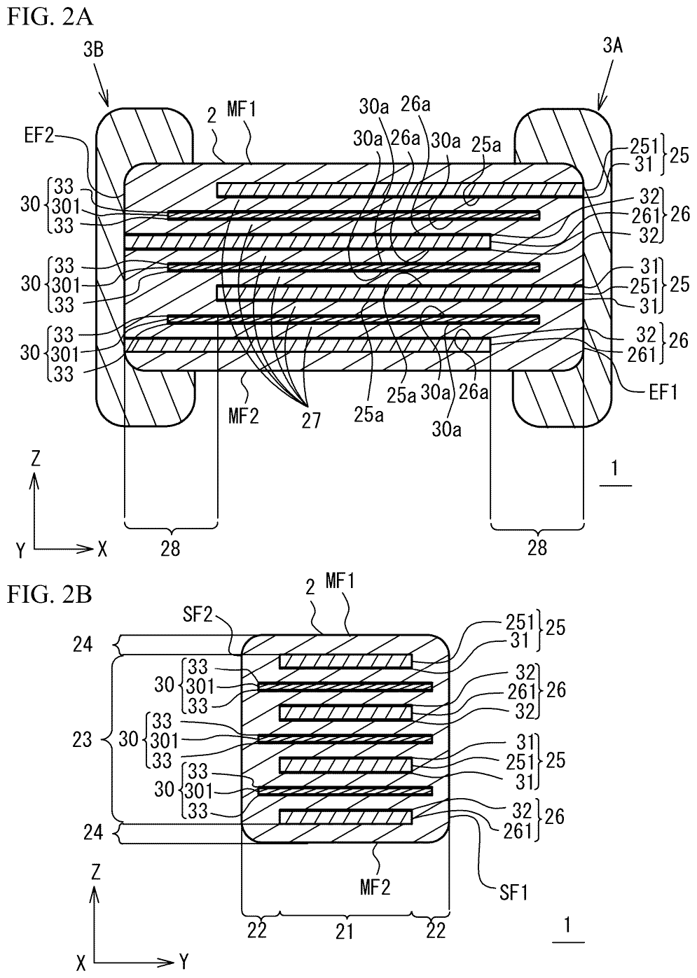

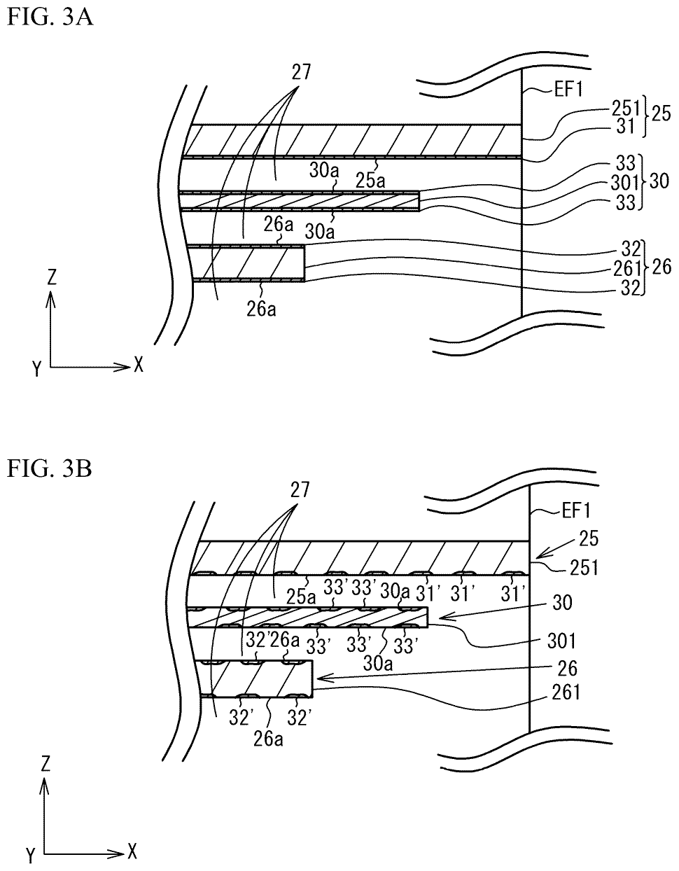

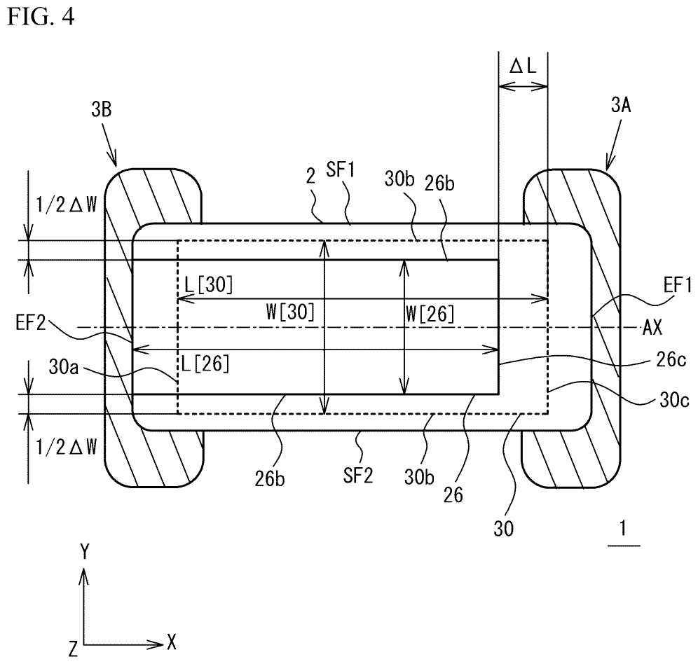

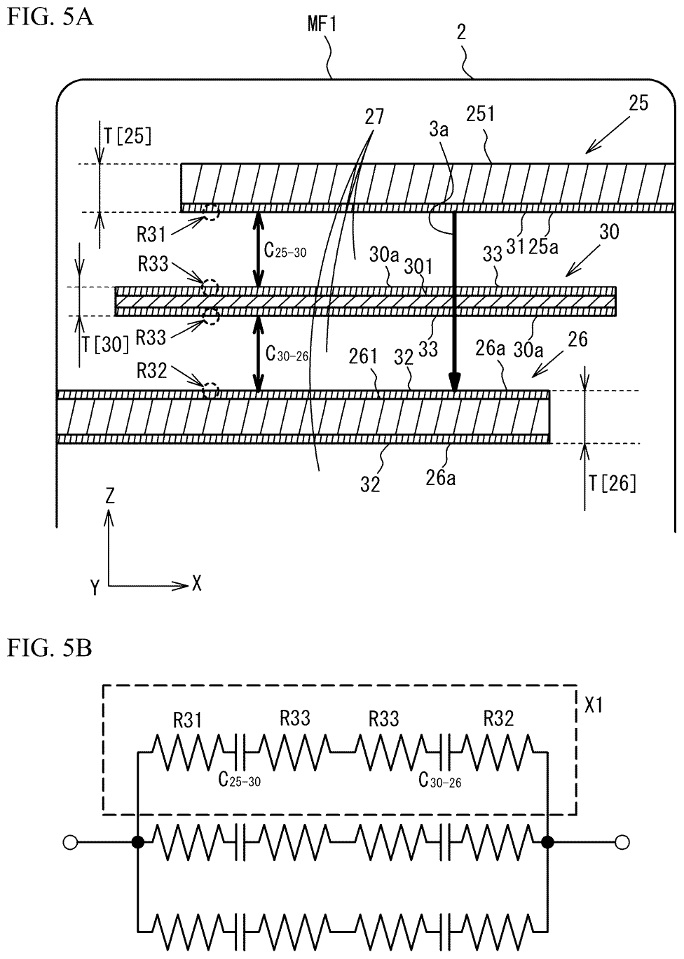

First, the multilayer ceramic capacitor (MLCC) 1 according to an embodiment will be described with reference to FIGS. 1 to 5. FIG. 1 is a perspective view of the multilayer ceramic capacitor 1. FIG. 2A is a cross-sectional view taken along line A-A in FIG. 1. FIG. 2B is a cross-sectional view taken along line B-B in FIG. 1. FIG. 3A is an explanatory view illustrating a first lead internal electrode 25, a first floating electrode 30, and a second lead internal electrode 26 in the first embodiment in an enlarged manner, and FIG. 3B is an explanatory view illustrating a variation of the first lead internal electrode 25, the first floating electrode 30, and the second lead internal electrode 26. FIG. 4 is a cross-sectional view taken along line C-C in FIG. 1. FIG. 5A is an explanatory view schematically illustrating the first lead internal electrode 25, the first floating electrode 30, and the second lead internal electrode 26 in the first embodiment, and FIG. 5B is a circuit diagram approximately illustrating a circuit provided in the multilayer ceramic capacitor according to the first embodiment. In the multilayer ceramic capacitor 1, the X-axis direction is the length direction, the Y-axis direction is the width direction, and the Z-axis direction is the height direction. Each cross-sectional view is schematically drawn in order to clearly illustrate the state of each cross-section. The first lead internal electrode 25, the first floating electrode 30, and the second lead internal electrode 26 illustrated in FIG. 5A are schematically illustrated for easy understanding of the description, and the aspect ratio and the scale ratio of each component are different from those of the components illustrated in other drawings.

The multilayer ceramic capacitor 1 includes a ceramic element 2, a first external electrode 3A provided at one end of the multilayer ceramic capacitor 1 in the length direction, and a second external electrode 3B provided at the other end of the multilayer ceramic capacitor 1.

### <Ceramic Element>

The ceramic element 2 is formed as a hexahedron having a first main surface MF1 and a second main surface MF2 (referring to FIG. 2A) orthogonal to the Z-axis, a first end surface EF1 and a second end surface EF2 (referring to FIG. 2A) orthogonal to the X-axis, and a first side surface SF1 and a second side surface SF2 (referring to FIG. 2B) orthogonal to the Y-axis. The “hexahedron” may be substantially a hexahedron, and for example, ridges connecting the surfaces of the ceramic element 2 may be rounded.

The first main surface MF1, the second main surface MF2, the first end surface EF1, the second end surface EF2, the first side surface SF1, and the second side surface SF2 of the ceramic element 2 are all formed as flat surfaces. The flat surface according to the present embodiment may not be strictly a plane as long as it is a surface recognized as flat when viewed as a whole, and includes, for example, a surface having a minute uneven shape of the surface, a gently curved shape existing in a predetermined range, or the like.

The ceramic element 2 includes a multilayer portion 21 and a pair of side margins 22. The multilayer portion 21 includes a capacitance forming portion 23 and a pair of cover layers 24. The capacitance forming portion 23 includes a plurality of first lead internal electrodes 25 and a plurality of second lead internal electrodes 26 that are alternately laminated with a plurality of dielectric layers 27 along the Z-axis direction. In addition, a first floating electrode 30 is provided in the capacitance forming portion 23. The first floating electrode 30 is provided between a pair of the first lead internal electrode 25 and the second lead internal electrode 26 via the dielectric layer 27 in the ceramic element 2. In the present embodiment, the first lead internal electrode 25, the second lead internal electrode 26, the dielectric layer 27, and the first floating electrode 30 are each configured in a sheet shape extending along the X-Y plane. In the present embodiment, the first lead internal electrode 25, the second lead internal electrode 26, the dielectric layer 27, and the first floating electrode 30 are each configured in a sheet shape extending along the X-Y plane. Each multilayer number of the first lead internal electrodes 25, the second lead internal electrodes 26, and the first floating electrodes 30 in each drawing does not represent the actual number of the multilayer.

### <<First and Second Lead Internal Electrodes>>

The first lead internal electrodes 25 and the second lead internal electrodes 26 are alternately arranged along the Z-axis direction (height direction) so as to face each other in the Z-axis direction. The first lead internal electrode 25 and the second lead internal electrode 26 face each other in the Z-axis direction in a facing region at the center in the X-axis direction and the Y-axis direction. The first lead internal electrodes 25 are lead out from the opposing region to the first end surface EF1, which is one of the end surfaces, through an end margin 28, and are connected to the first external electrode 3A. The second lead internal electrodes 26 are lead out from the facing region to the second end surface EF2 through the end margin 28, and are connected to the second external electrode 3B.

Referring to FIGS. 2A to 3A, the first lead internal electrode 25 includes a boundary layer 31 that form a facing surface 25a facing the first floating electrode 30 provided between the first lead internal electrodes 25 and the second lead internal electrodes 26. The boundary layer 31 corresponds to a first boundary layer that is in contact with the dielectric layer 27 laminated between the first floating electrode 30 and the dielectric layer 27 and forms a boundary therebetween.

The boundary layer 31 is formed in a state of being laminated on a core material 251 included in the first lead internal electrode 25.

The first lead internal electrodes 25 illustrated in FIG. 3A is the uppermost layer, and the facing surface 25a facing the first floating electrode 30 is only one surface, so that the first lead internal electrode 25 of the uppermost layer illustrated in FIG. 3A is provided with one layer of the boundary layer 31. In contrast, as illustrated in FIGS. 2A and 2B, in the first lead internal electrodes 25, both surfaces in the Z-axis direction are the facing surfaces 25a, and the boundary layers 31 are provided on both surface sides of the core material 251 in the Z-axis direction.

Although the core material 251 is made of Ni (nickel), the material thereof can be selected from metals such as Cu (copper), Fe (iron), Zn (zinc), Al (aluminum), Sn (tin), Ni (nickel), Ti (titanium), Ag (silver), Au (gold), Pt (platinum), Pd (palladium), Ta (tantalum), or W (tungsten), and may be an alloy containing these metals.

The material contained in the boundary layer 31 will be described in detail later.

Referring to FIG. 5, a size of the first lead internal electrode 25 in the direction along the Z-axis direction is a thickness T[25].

The second lead internal electrode 26 includes a boundary layer 32 forming a facing surface 26a facing the first floating electrode 30 provided between the first lead internal electrode 25 and the second lead internal electrode 26. The boundary layer 32 corresponds to a first boundary layer that forms a boundary with the dielectric layer 27 laminated between the first floating electrode 30 and the dielectric layer 27.

The boundary layer 32 is formed in a state of being laminated on a core material 261 included in the second lead internal electrode 26, similarly to the boundary layer 31 formed in the first lead internal electrode 25. When the second lead internal electrode 26 is the uppermost layer or the lowermost layer, the facing surface 26a is only one surface, and therefore, in this case, one layer of the boundary layer 32 is provided. In the second lead internal electrodes 26, as illustrated in FIGS. 2A to 3A, both surfaces in the Z-axis direction are the facing surfaces 26a, and the boundary layers 32 are provided on both surface sides of the core material 261 orthogonal to the Z-axis.

The core material 261 in the present embodiment is similar to the core material 251 of the first lead internal electrode 25, and therefore, detailed description thereof is omitted here. The material contained in the boundary layer 32 will be described in detail later together with the material contained in the boundary layer 31.

Referring to FIG. 4, a size of the second lead internal electrode 26 in the direction along the X-axis direction is a length L[26], and a size thereof along the Y-axis direction is a width W[26]. Although the first lead internal electrode 25 is not illustrated in FIG. 4, the length and the width of the first lead internal electrode 25 are set to the same values as the length L[26] and width W[26] of the second lead internal electrode 26. Referring to FIG. 5A, a size of the second lead internal electrode 26 in the direction along the Z-axis direction is a thickness T[26]. The thickness T[26] is the same value as the thickness T[25] of the first lead internal electrode 25.

### <<First Floating Electrode>>

The first floating electrode 30 is disposed between the first lead internal electrode 25 and the second lead internal electrode 26. Therefore, both surfaces of the first floating electrodes 30 perpendicular to the Z-axis form facing surfaces 30a facing the first lead internal electrode 25 and the second lead internal electrode 26, respectively. The facing surfaces 30a are each formed by a boundary layer 33. One of the boundary layers 33 corresponds to a first boundary layer that forms a boundary with the dielectric layer 27 laminated between the first lead internal electrode 25 and the dielectric layer 27. The other of the boundary layers 33 corresponds to a first boundary layer that forms a boundary with the dielectric layer 27 laminated between the second lead internal electrode 26 and the dielectric layer 27.

The boundary layer 33 is formed in a state of being laminated on a core material 301 included in the first floating electrode 30, similarly to the boundary layer 31 formed in the first lead internal electrode 25 and the boundary layer 32 formed in the second lead internal electrode 26. The boundary layers 33 are provided on both surfaces of the core material 301 opposing each other in the Z-axis direction.

The core material 301 in the present embodiment can be formed in the same manner as the core material 251 of the first lead internal electrode 25 and the core material 261 of the second lead internal electrode 26. Therefore, the detailed description thereof is omitted here. The material contained in the boundary layer 33 will be described later in detail together with the materials contained in the boundary layer 31 and the boundary layer 32.

Referring to FIG. 4, the size of the first floating electrode 30 in the direction along the X-axis direction is a length L[30], and the size along the Y-axis direction is a width W[30]. Referring to FIG. 5A, the size of the first floating electrode 30 in the direction along the Z-axis direction is a thickness T[30].

Here, referring again to FIG. 4, the relationship between the length L[26] and the width W[26] of the second lead internal electrode 26 and the length L[30] and the width W[30] of the first floating electrode 30 will be described. The relationship between the sizes of the first floating electrode 30 and the sizes of the first lead internal electrode 25 is the same as the relationship between the sizes of the first floating electrode 30 and the sizes of the second lead internal electrode 26, and therefore, the description thereof is omitted here.

The width W[30] of the first floating electrode 30 is larger than the width W[26] of the second lead internal electrode 26. That is, the width W[30] is larger than the width W[26] by ΔW. Specifically, ΔW can be set in a range of 1 μm or more and 300 μm or less. Note that ΔW is set to halves along the Y-axis direction. That is, the first floating electrode 30 is larger than the second lead internal electrode 26 by ½ ΔW in each of the width directions with respect to a central axis AX in the Y-axis direction as illustrated in FIG. 4. In the present embodiment, side edges 30b along the X-axis direction of the first floating electrode 30 are positioned on the outer side in the Y-axis direction with respect to side edges 26b along the X-axis direction of the second lead internal electrode 26. The width W[30] and the width W[26] can be appropriately set in accordance with the size of the multilayer ceramic capacitor 1 described later.

An end portion 30c of the first floating electrode 30 in the X-axis direction is located close to the first external electrode 3A, and an end portion 26c of the second lead internal electrode 26 not connected to the first external electrode 3A is far from the first external electrode 3A, that is, the end portion 30c is located outside in the X-axis direction as compared with the end portion 26c. This positional relationship is also true for the relationship with the first lead internal electrode 25. The end portion 30c of the first floating electrode 30 in the length direction is positioned closer to the external electrode by ΔL than the end portion of the internal electrode. Specifically, ΔL can be set in a range of 1 μm or more and 300 μm or less. Although the length L[26] is greater than the length L[30] in the present embodiment, the length L[30] and the length L[26] may be appropriately set in accordance with the size of the multilayer ceramic capacitor 1 described later. The length L[30] and the length L[26] may have any magnitude relationship.

As described above, in the present embodiment, the side edges 30b along the X-axis direction of the first floating electrode 30 are located on the outer side in the Y-axis direction with respect to the side edges 26b along the X-axis direction of the second lead internal electrode 26. The end portion 30c of the first floating electrode 30 in the X-axis direction is located on the outer side in the X-axis direction with respect to the end portions of the internal electrodes in the X-axis direction that are not connected to the external electrodes. This can suppress the movement of oxygen deficiency in the laminated direction (Z-axis direction) from the first lead internal electrode 25 toward the second lead internal electrode 26 as indicated by an arrow 3a in FIG. 5A. By suppressing the movement of the oxygen defects in the laminated direction, current leakage, that is, breakdown voltage, can be suppressed. This is considered to be because the oxygen defects moving around in the laminated direction can be suppressed by providing the first floating electrode 30 having such a size relationship.

Next, referring again to FIG. 5A, the thickness T[30] of the first floating electrode 30 is smaller than each of the thickness T[25] of the first lead internal electrode 25 and the thickness T[26] of the second lead internal electrode 26. To be specific, the thickness T[25] and the thickness T[26] can be set to be equal to or larger than 10 nm and equal to or smaller than 1000 nm. On the other hand, the thickness T[30] can be set to be equal to or greater than 1 nm and equal to or less than 1000 nm.

The first lead internal electrode 25 and the second lead internal electrode 26 are connected to the first external electrode 3A and the second external electrode 3B, respectively. Therefore, the first lead internal electrode 25 and the second lead internal electrode 26 are required to have certain thicknesses in order to ensure reliable electrical conduction with the first external electrode 3A and the second external electrode 3B. In contrast, the first floating electrode 30 is not connected to an external electrode. Therefore, the thickness of the first floating electrode 30 may be thin, as compared with each of the first lead internal electrode 25 and the second lead internal electrode 26. By setting the thickness T[30] of the first floating electrode 30 to a value smaller than each thickness of the first lead internal electrode 25 and the second lead internal electrode 26, the size of the ceramic element 2 in the thickness direction is reduced, and the capacitance value per unit volume of the multilayer ceramic capacitor 1 is able to be improved.

### <<Material Contained in Boundary Layer>>

Next, the material contained in the boundary layers 31, 32, and 33 will be described. The boundary layers 31, 32, and 33 can employ a common structure. Therefore, in the following description, the boundary layer 31 will be described as a representative. The boundary layer 31 in the present embodiment is formed of Au (gold), but the boundary layer 31 may be configured to include at least one of Au, Pt (platinum), Ag (silver), Fe (iron), Sn (tin), Ge (germanium), Hf (hafnium), In (indium), Si (silicon), V (vanadium), or Y (yttrium).

These materials are materials that increase the Schottky barrier at the interface and can improve the insulation property.

The boundary layer 31 forms a boundary with the dielectric layer 27. The boundary layer 31 contains the materials listed above, and thus has a high barrier to a current, and exhibits an effect as if a resistance component is formed at the interface. That is, the boundary layer 31 is considered to generate the Schottky barrier, and improve the withstand voltage of the multilayer ceramic capacitor 1.

The boundary layer 31 can be formed by applying a material for forming the boundary layer 31 on a green sheet before or after applying a conductive paste for forming the first lead internal electrode 25 on the green sheet in a process of manufacturing the multilayer ceramic capacitor 1. That is, the material for forming the boundary layer 31 is applied onto the green sheet, then a conductive paste for forming the first lead internal electrode 25 is applied thereon. Then, the boundary layer 31 can be formed by further applying a material for forming the boundary layer 31 thereon. The boundary layer 32 included in the second lead internal electrode 26 and the boundary layer 33 included in the first floating electrode 30 can be formed in the same manner.

Although the boundary layers 31, 32, and 33 are provided over the entire regions of the facing surfaces 25a, 26a, and 30a of the internal electrodes in the X-axis direction as illustrated in FIG. 3A, the boundary layers may be intermittently formed on the facing surfaces 25a, 26a, and 30a of the internal electrodes along the X-axis direction like boundary layers 31′, 32′, and 33′ illustrated in FIG. 3B.

### <Laminated Portion>

In the multilayer portion 21, a dielectric ceramic having a high dielectric constant is used in order to increase the capacitance of each dielectric layer 27 between the first lead internal electrode 25 and the second lead internal electrode 26. Examples of the dielectric ceramics having a high dielectric constant include materials having a perovskite structure containing barium (Ba) and titanium (Ti), typified by barium titanate (BaTiO₃).

The dielectric ceramics may be a composition system such as strontium titanate (SrTiO₃), calcium titanate (CaTiO₃), magnesium titanate (MgTiO₃), calcium zirconate (CaZrO₃), calcium zirconate titanate (Ca (Zr, Ti) O₃), barium calcium zirconate titanate ((Ba, Ca) (Zr, Ti) O₃), barium zirconate (BaZrO₃), and titanium oxide (TiO₂). Here, a low melting point metal may be added to the dielectric ceramics instead of or in addition to the addition of the low melting point metal to the first lead internal electrode 25 and the second lead internal electrode 26.

The pair of the cover layers 24 covers the capacitance forming portion 23 from both sides in the Z-axis direction as a laminating direction. The cover layer 24 may also be referred to as a protective layer in the height direction. The cover layer 24 is formed of, for example, a multilayer body having ceramic sheets extending along the X-Y plane. The dielectric ceramics constituting the cover layer 24 preferably has the same composition as the dielectric layer 27 from the viewpoint of suppressing internal stress and the like.

The pair of the side margins 22 are formed along the Z-axis direction and cover the multilayer portion 21 from the Y-axis direction. The side margin 22 may be referred to as a protective layer in the width direction. The side margin 22 is formed on a surface of the multilayer portion 21 orthogonal to the Y-axis direction. The dielectric ceramics constituting the side margins 22 preferably has the same composition as the dielectric layers 27 from the viewpoint of reducing internal stress and the like.

### <External Electrode>

The multilayer ceramic capacitor 1 includes the first external electrode 3A provided at one end of the multilayer ceramic capacitor 1 in the length direction (X-axis direction) and the second external electrode 3B provided at the other end of the multilayer ceramic capacitor 1.

The first external electrode 3A and the second external electrode 3B contain a metallic material as a main component. Examples of the metallic material constituting the first external electrode 3A and the second external electrode 3B include copper (Cu), nickel (Ni), tin (Sn), palladium (Pd), platinum (Pt), silver (Ag), gold (Au), and alloys thereof. In the present embodiment, the main component refers to a component having the highest content ratio.

With this configuration, in the multilayer ceramic capacitor 1, when a voltage is applied between the first external electrode 3A and the second external electrode 3B, the voltage is applied to the plurality of the dielectric layers 27 between the first lead internal electrode 25 and the second lead internal electrode 26 in the opposing region. Thus, in the multilayer ceramic capacitor 1, electric charges corresponding to the voltage between the first external electrode 3A and the second external electrode 3B are stored.

In the first external electrode 3A and the second external electrode 3B, both the cross section parallel to the X-Z plane and the cross section parallel to the X-Y plane have a U shape. The shapes of the first external electrode 3A and the second external electrode 3B are not limited to the examples illustrated in the drawings.

The size of the multilayer ceramic capacitor 1 is not particularly limited, but for example, as designed values, any one of the sizes of 0.25 mm long, 0.125 mm wide, and 0.125 mm high (0201 size), 0.4 mm long, 0.2 mm wide, and 0.2 mm high (0402 size), 0.6 mm long, 0.3 mm wide, and 0.3 mm high (0603 size), 1.0 mm wide, 0.5 mm wide, and 0.5 mm high (1005 size), 3.2 mm wide, 1.6 mm wide, and 1.6 mm high (3216 size), 4.5 mm wide, 3.2 mm wide, and 2.5 mm high (4532 size), and 5.7 mm wide, 5.0 mm wide, and 2.3 mm high (5750 size) can be selected. The size of the multilayer ceramic capacitor 1 may be smaller than 0402 size, that is, any one of the length, width, and height of the multilayer ceramic capacitor 1 may be smaller than 0402 size.

Next, a circuit formed in the multilayer ceramic capacitor 1 will be described with reference to FIGS. 5A and 5B.

FIG. 5B is a circuit diagram approximately illustrating a circuit formed in the multilayer ceramic capacitor 1, and FIG. 5A schematically illustrates components corresponding to a X1 portion illustrated in FIG. 5B.

The boundary layer 31 forming the boundary surface with the dielectric layer 27 generates the Schottky barrier, which has an effect as if a resistive element is provided. Therefore, in FIGS. 5A and 5B, the boundary layer 31 is illustrated as a resistance element R31. Similarly, the boundary layer 33 forming the boundary surface with the dielectric layer 27 is illustrated as the resistive element R33 because the boundary layer 33 provides the Schottky barrier and produces an effect similar that of a resistive element. The same is true of the boundary layers 32, which are illustrated as resistive elements R32.

A distance between the first lead internal electrode 25 and the first floating electrode 30 is illustrated as a capacitive element C₂₅₋₃₀. The distance between the first floating electrodes 30 and the second lead internal electrodes 26 is illustrated as a capacitive element C₃₀₋₂₆.

Although each internal electrode serves as a resistance element, the resistance element formed by each internal resistance is omitted in FIG. 5B.

As described above, the multilayer ceramic capacitor 1 according to the present embodiment includes the boundary layer that generates the Schottky barrier in each portion. Therefore, the withstand voltage can be improved.

### Second Embodiment

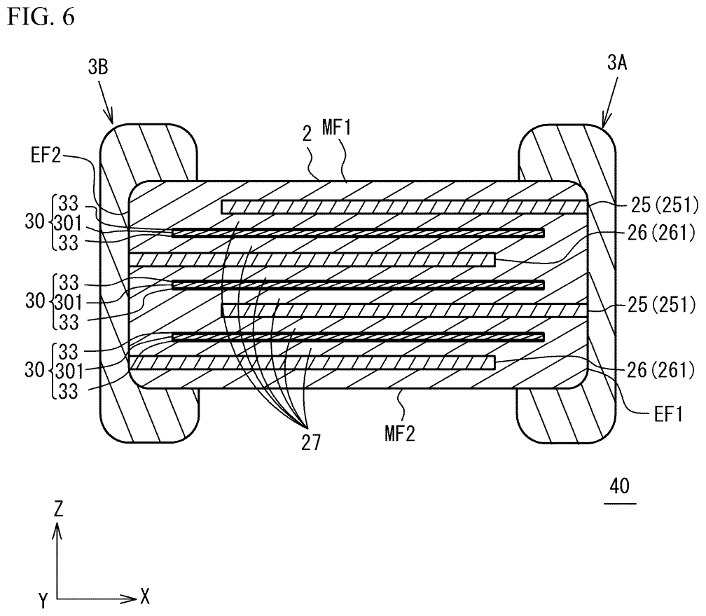

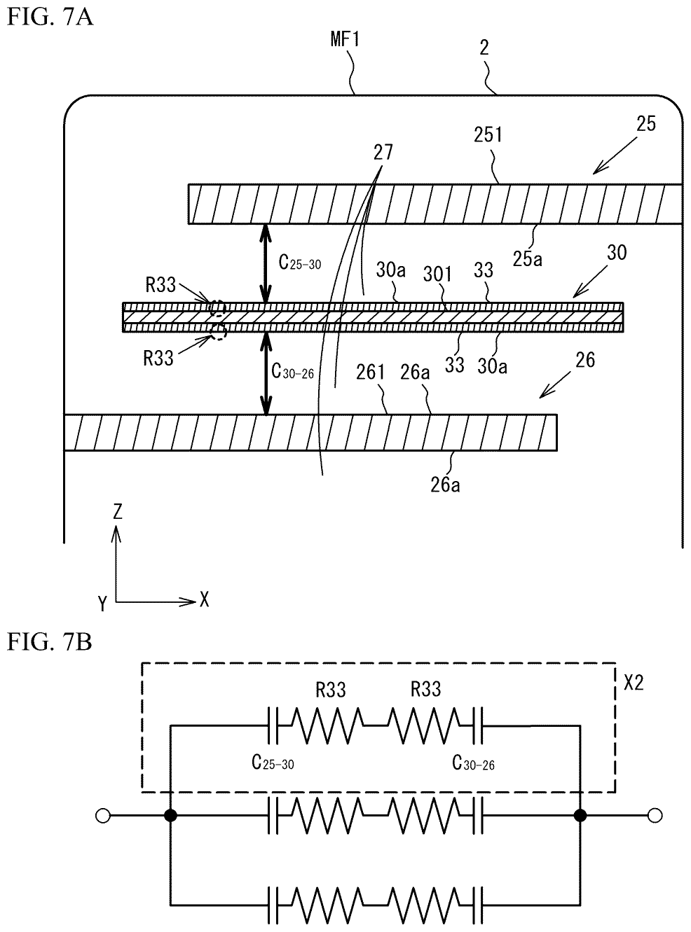

Next, a multilayer ceramic capacitor 40 according to a second embodiment will be described with reference to FIGS. 6 to 7B. FIG. 6 is a cross-sectional view of the multilayer ceramic capacitor 40 taken along a line corresponding to the line A-A in FIG. 1. FIG. 7A is an explanatory view schematically illustrating the first lead internal electrode 25, the first floating electrode 30, and the second lead internal electrode 26 in the second embodiment, and FIG. 7B is a circuit diagram approximately illustrating a circuit formed in the multilayer ceramic capacitor 40.

The multilayer ceramic capacitor 40 according to the second embodiment differs from the multilayer ceramic capacitor 1 according to the first embodiment in the following points. The multilayer ceramic capacitor 1 according to the first embodiment includes the boundary layer 31 provided in the first lead internal electrode 25 and the boundary layer 32 provided in the second lead internal electrode 26. In contrast, the boundary layers 31 and 32 are omitted in the multilayer ceramic capacitor 40 according to the second embodiment. That is, the multilayer ceramic capacitor 40 according to the second embodiment includes boundary layers 33 only in the first floating electrode 30.

FIG. 7A schematically illustrates a component corresponding to an X2 portion illustrated in FIG. 7B. In the multilayer ceramic capacitor 40, the boundary layer 33 also generates the Schottky barrier, and thus the withstand voltage can be improved.

A configuration equivalent to the circuit diagram illustrated in FIG. 7B can be obtained by providing a boundary layer on the facing surface 25a of the first lead internal electrode 25 and on the facing surface 26a of the second lead internal electrode 26, and not providing a boundary layer on the first floating electrode 30. However, when the boundary layers are provided on the facing surface 25a of the first lead internal electrode 25 and the facing surface 26a of the second lead internal electrode 26, the total number of layers of the lead internal electrodes is increased by one layer as compared with the number of layers of the first floating electrodes 30. This is because, when the boundary layer is provided on the first floating electrode 30, the boundary layer can be provided on both surfaces thereof. Therefore, in order to obtain a configuration equivalent to the circuit diagram illustrated in FIG. 7B, it is more efficient to provide the boundary layers 33 on both surfaces of the first floating electrode 30.

### Third Embodiment

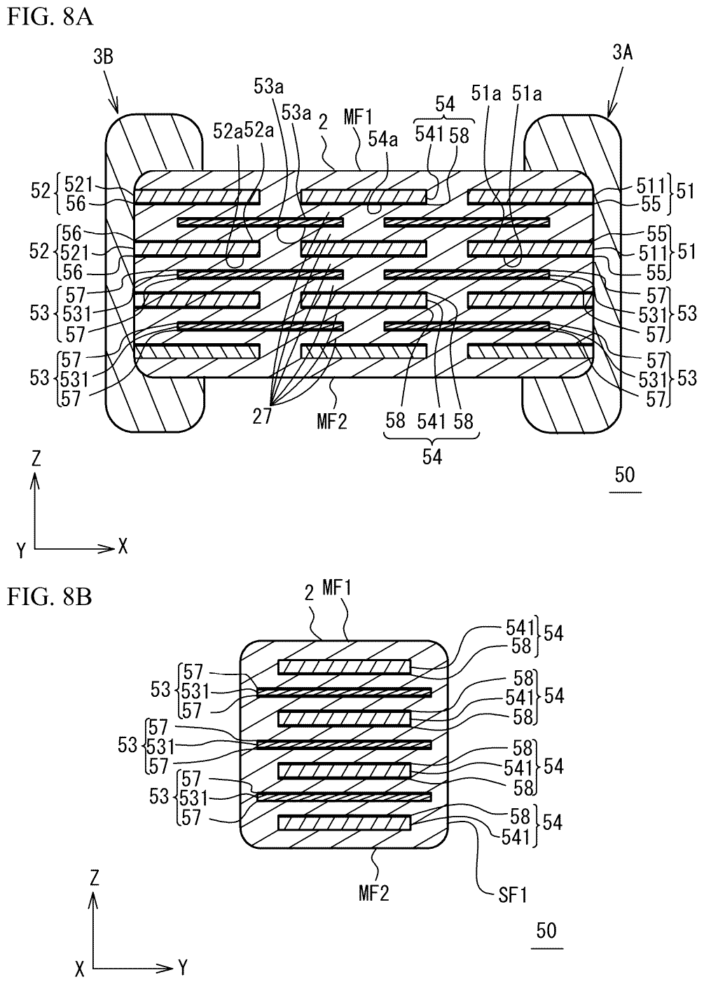

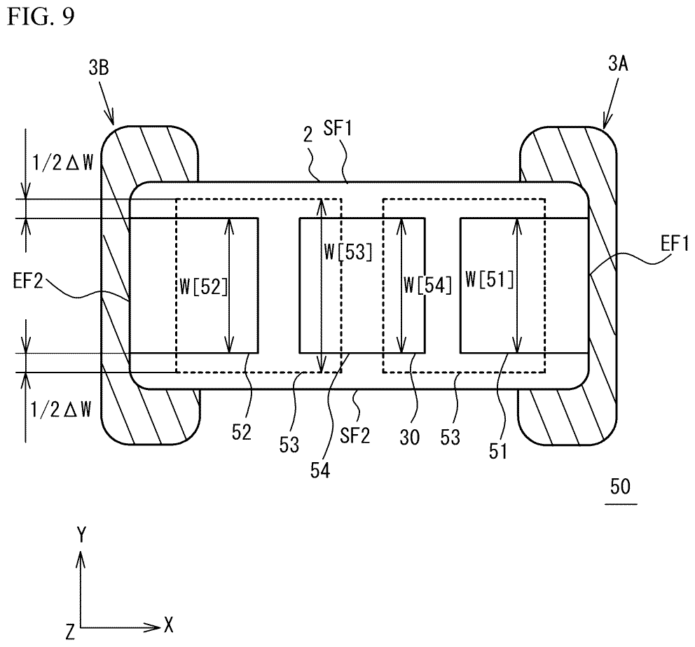

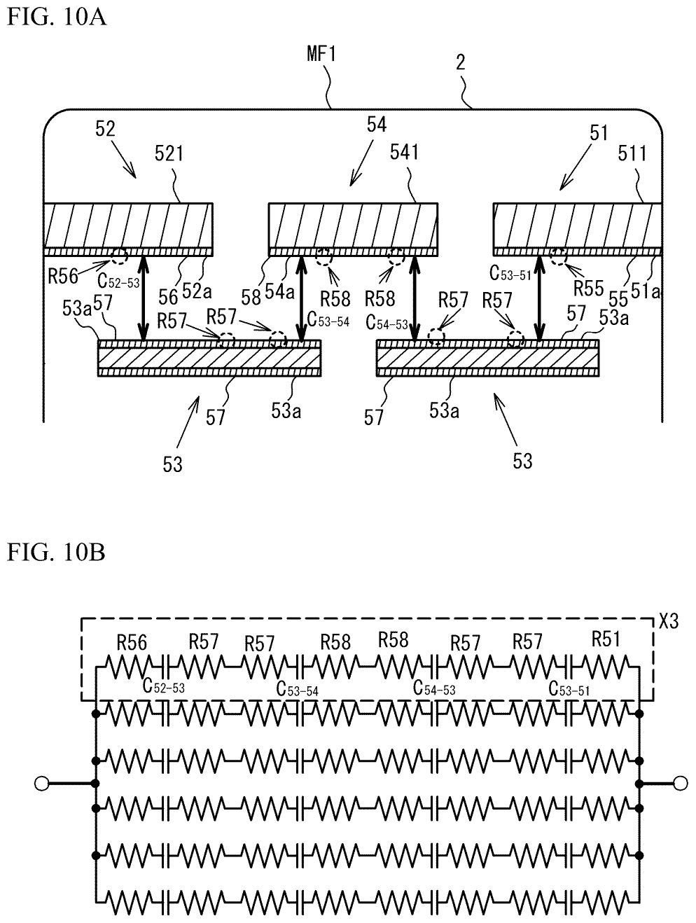

Next, a multilayer ceramic capacitor 50 according to a third embodiment will be described with reference to FIGS. 8A to 10B. FIG. 8A is a cross-sectional view of the multilayer ceramic capacitor 50 taken along a line corresponding to line A-A in FIG. 1, and FIG. 8B is a cross-sectional view of the multilayer ceramic capacitor 50 taken along a line corresponding to line B-B in FIG. 1. FIG. 9 is a cross-sectional view of the multilayer ceramic capacitor 50 taken along a line corresponding to line C-C in FIG. 1. FIG. 10A is an explanatory view schematically illustrating a third lead internal electrode 51, a first floating electrode 53, a second floating electrode 54, and a fourth lead internal electrode 52, and FIG. 10B is a circuit diagram approximately illustrating a circuit formed in the multilayer ceramic capacitor according to the third embodiment.

The multilayer ceramic capacitor 50 according to the third embodiment includes the third lead internal electrodes 51 and the fourth lead internal electrodes 52 instead of the first lead internal electrodes 25 and the second lead internal electrodes 26 included in the multilayer ceramic capacitor 1 according to the first embodiment. The pair of the third lead internal electrode 51 and the fourth lead internal electrode 52 is not laminated in the Z-axis direction, but is disposed along the X-axis direction with a space therebetween.

The multilayer ceramic capacitor 50 according to the third embodiment includes the first floating electrodes 53 laminated in the Z-axis direction similarly to the multilayer ceramic capacitor 1 according to the first embodiment, but the two first floating electrodes 53 are provided at the same height position, and these are arranged in parallel along the X-axis direction.

The multilayer ceramic capacitor 50 according to the third embodiment includes the second floating electrodes 54 disposed between the third lead internal electrodes 51 and the fourth lead internal electrodes 52 along the X-axis direction.

One of the two first floating electrodes 53 provided at the same height position faces the third lead internal electrode 51 and the second floating electrode 54 along the Z-axis direction via the dielectric layer 27. The other of the first floating electrodes 53 faces the fourth lead internal electrode 52 and the second floating electrode 54 along the Z-axis direction via the dielectric layer 27.

The third lead internal electrode 51 includes boundary layers 55 formed by being laminated on a core material 511. The fourth lead internal electrode 52 includes boundary layers 56 formed by being laminated on a core material 521. The first floating electrode 53 includes boundary layers 57 formed by being laminated on a core material 531. The second floating electrode 54 includes a boundary layer 58 formed by being laminated on a core material 541. The boundary layer 58 corresponds to a second boundary layer that forms a boundary between the dielectric layer 27 and the second floating electrode 54.

The boundary layers 55, 56, 57, and 58 are formed in the same manner as the boundary layers 31, 32, and 33 in the first embodiment.

Here, sizes of the respective portions will be described with reference to FIG. 9. A width W[53] of the first floating electrode 53 is larger than each of a width W[51] of the third lead internal electrode 51, a width W[52] of the fourth lead internal electrode 52, and a width W[54] of the second floating electrode 54. This can suppress the movement of oxygen defects in the laminated direction, and can suppress current leakage, that is, breakdown voltage.

Next, a circuit formed in the multilayer ceramic capacitor 50 will be described with reference to FIGS. 10A and 10B.

FIG. 10B is a circuit diagram approximately illustrating a circuit formed in the multilayer ceramic capacitor 50, and FIG. 10A schematically illustrates components corresponding to an X3 portion illustrated in FIG. 10B.

The boundary layer 55 is illustrated as a resistive element R55. The boundary layer 56 is illustrated as a resistive element R56. The boundary layer 57 is illustrated as a resistive element R57. The boundary layer 58 is illustrated as a resistive element R58.

A distance between the third lead internal electrode 51 and the first floating electrode 53 is illustrated as a capacitive element C₅₃₋₅₁. A distance between the first floating electrode 53 and the second floating electrode 54 is illustrated as a capacitive element C₅₃₋₅₄ or C₅₄₋₅₃. A distance between the first floating electrode 30 and the fourth lead internal electrode 52 is illustrated as a capacitive element C₅₂₋₅₃.

As described above, the multilayer ceramic capacitor 50 according to the present embodiment includes the boundary layer that generates the Schottky barrier in each portion. Therefore, the withstand voltage can be improved.

### Fourth Embodiment

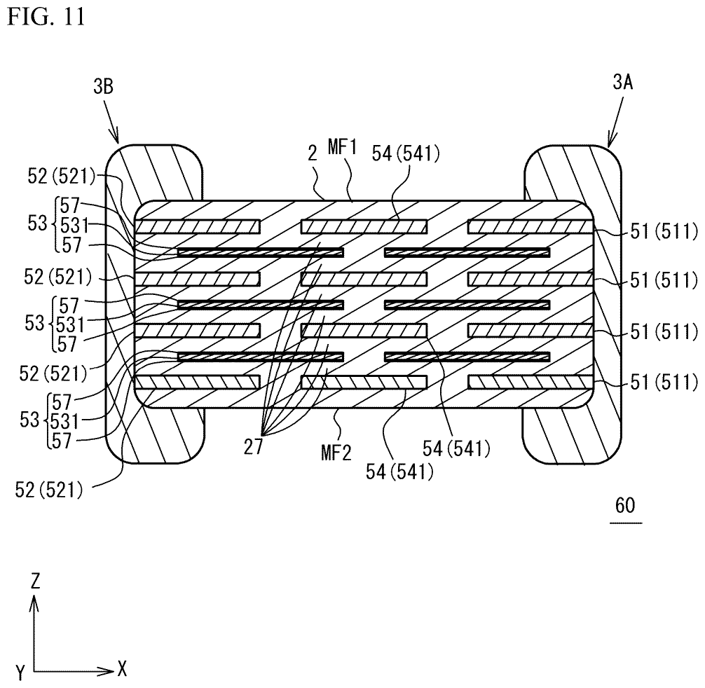

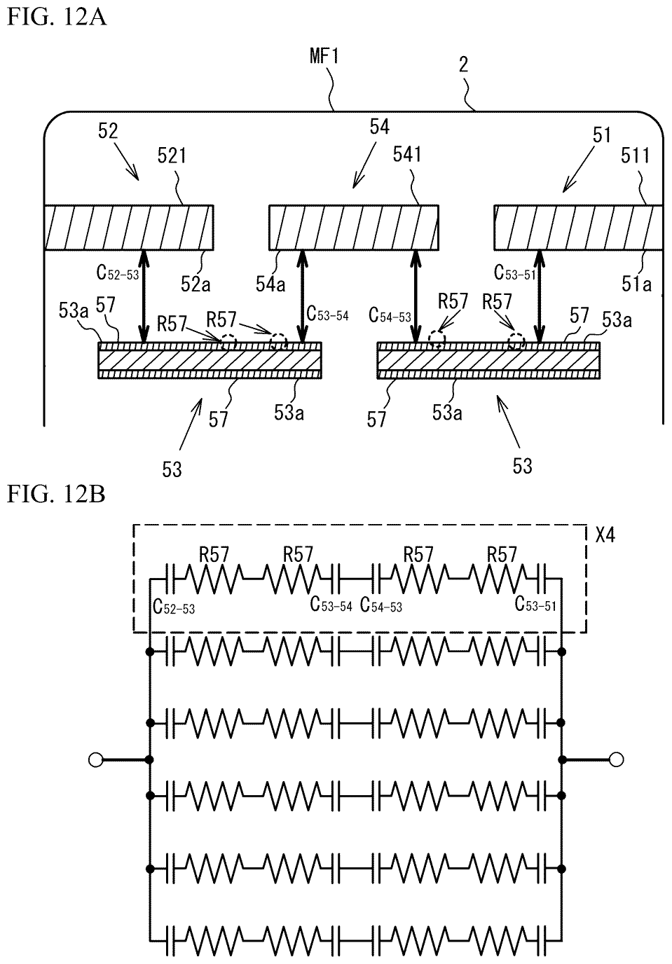

Next, a multilayer ceramic capacitor 60 according to a fourth embodiment will be described with reference to FIGS. 11 to 12B. FIG. 11 is a cross-sectional view of the multilayer ceramic capacitor 60 according to the fourth embodiment taken along a line corresponding to the line A-A in FIG. 1. FIG. 12A is an explanatory view schematically illustrating the third lead internal electrode 51, the first floating electrode 53, the second floating electrode 54, and the fourth lead internal electrode 52 in the fourth embodiment, and FIG. 12B is a circuit diagram approximately illustrating a circuit provided in the multilayer ceramic capacitor 60.

The multilayer ceramic capacitor 60 according to the fourth embodiment differs from the multilayer ceramic capacitor 50 according to the third embodiment in the following points. The multilayer ceramic capacitor 50 according to the third embodiment includes the boundary layer 55 provided in the third lead internal electrode 51, the boundary layer 56 provided in the fourth lead internal electrode 52, and the boundary layer 58 provided in the second floating electrode 54. In contrast, the boundary layers 55, 56, and 58 are omitted in the multilayer ceramic capacitor 60 according to the fourth embodiment. That is, the multilayer ceramic capacitor 60 according to the fourth embodiment includes the boundary layers 57 only in the first floating electrode 53.

FIG. 12A schematically illustrates a component corresponding to an X4 portion illustrated in FIG. 12B. In such a multilayer ceramic capacitor 60, the boundary layer 57 also generates the Schottky barrier, and thus the withstand voltage can be improved.

Note that a configuration equivalent to the circuit diagram illustrated in FIG. 12B can be obtained by providing boundary layers on a facing surface 51a of the third lead internal electrode 51, a facing surface 52a of the fourth lead internal electrode 52, and a facing surface 54a of the second floating electrode 54, and not providing a boundary layer on a facing surface 53a of the first floating electrode 53. However, when the boundary layers are provided on the facing surface 51a of the third lead internal electrode 51, the facing surface 52a of the fourth lead internal electrode 52, and the facing surface 54a of the second floating electrode 54, the total number of layers of the lead internal electrodes and the second floating electrodes is increased by one layer as compared with the number of layers of the first floating electrodes 53. This is because, when the boundary layer is provided on the first floating electrode 53, the boundary layer can be provided on both surfaces thereof. Therefore, in order to obtain a configuration equivalent to the circuit diagram illustrated in FIG. 12B, it is more efficient to provide the boundary layers 57 on both surfaces of the first floating electrode 53.

### Fifth Embodiment

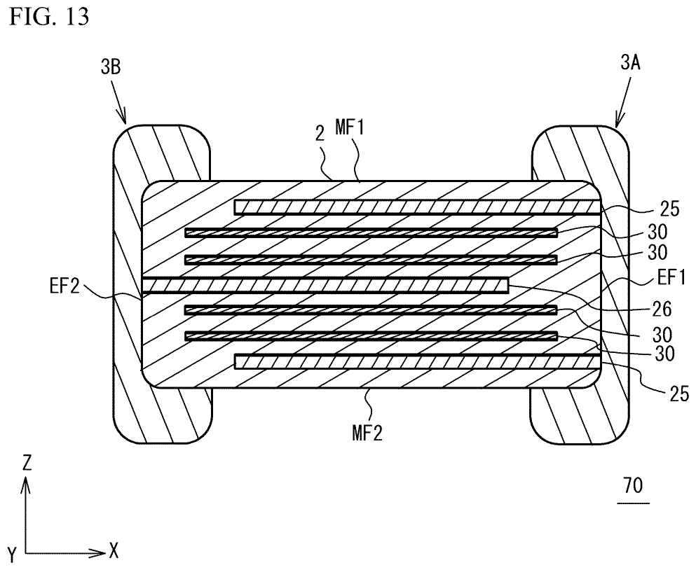

Next, a multilayer ceramic capacitor 70 according to a fifth embodiment will be described with reference to FIG. 13. FIG. 13 is a cross-sectional view of the multilayer ceramic capacitor 70 according to the fifth embodiment taken along a line corresponding to line A-A in FIG. 1.

A basic configuration of the multilayer ceramic capacitor 70 according to the fifth embodiment is the same or substantially the same as that of the multilayer ceramic capacitor 1 according to the first embodiment, except that the number of laminated layers of the first floating electrodes 30 disposed between the pair of the first lead internal electrode 25 and the second lead internal electrode 26 is increased from one to two.

With such a structure, the number of portions where the Schottky barriers are generated is increased. Therefore, the withstand voltage of the multilayer ceramic capacitor 70 is able to be further improved. The number of layers of the first floating electrode 30 is not limited to two, and may be more than two. In addition, the number of layers of the first floating electrode 30 may be increased based on the configuration of the multilayer ceramic capacitor 40 according to the second embodiment.

### Sixth Embodiment

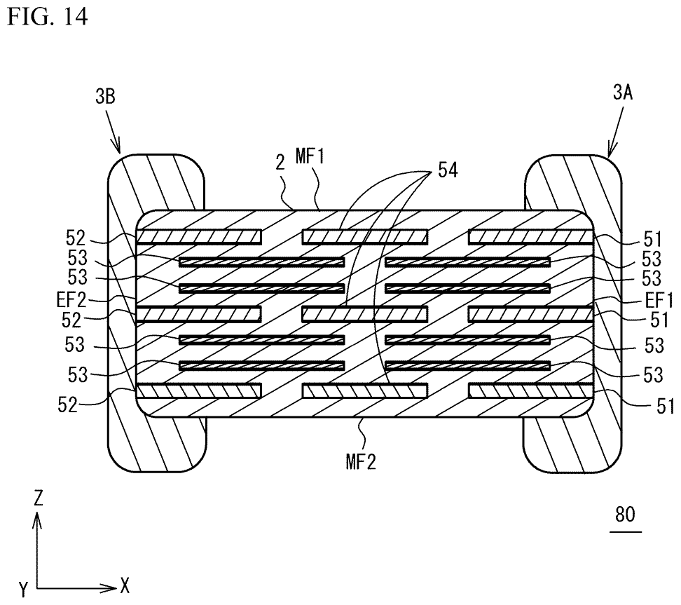

Next, a multilayer ceramic capacitor 80 according to a sixth embodiment will be described with reference to FIG. 14. FIG. 14 is a cross-sectional view of the multilayer ceramic capacitor 80 according to the sixth embodiment taken along a line corresponding to line A-A in FIG. 1.

The basic configuration of the multilayer ceramic capacitor 80 according to the sixth embodiment is the same or substantially the same as that of the multilayer ceramic capacitor 50 according to the third embodiment, but the number of laminated layers of the first floating electrodes 53 disposed between the pair of the third lead internal electrodes 51 or between the pair of fourth lead internal electrodes 52 is increased from one to two.

With such a structure, the number of portions where the Schottky barrier is generated is increased. Therefore, the withstand voltage of the multilayer ceramic capacitor 80 is able to be further improved. The number of layers of the first floating electrode 53 is not limited to two, and may be more than two. Further, the number of layers of the first floating electrode 53 may be increased based on the configuration of the multilayer ceramic capacitor 60 according to the fourth embodiment.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic electronic component comprising:
a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction;
a first external electrode provided at an end portion of the ceramic element in the third axis direction; and
a second external electrode provided at another end portion of the ceramic element in the third axis direction,
wherein
the internal electrode includes
an lead internal electrode connected to the first external electrode or the second external electrode, and
a first floating electrode facing the lead internal electrode along the first axis direction via the dielectric layer in the ceramic element and provided in a state of being separated from the first external electrode and the second external electrode,
at least one of the lead internal electrode and the first floating electrode includes a first boundary layer in contact with the dielectric layer formed between the lead internal electrode and the first floating electrode, and
the first boundary layer includes at least one of Au, Pt, Ag, Fe, Sn, Ge, Hf, In, Si, V, or Y.

2. The multilayer ceramic electronic component according to claim 1, wherein
the lead internal electrode includes
a first lead internal electrode led out to a side of the ceramic element in the third axis direction and connected to the first external electrode, and
a second lead internal electrode disposed to be shifted from the first lead internal electrode in the first axis direction, led out to another side of the ceramic element in the third axis direction, and connected to the second external electrode, and
the first floating electrode is provided between the first lead internal electrode and the second lead internal electrode via the dielectric layer in the ceramic element.

3. The multilayer ceramic electronic component according to claim 1, wherein
the first boundary layer is provided only on the first floating electrode.

4. The multilayer ceramic electronic component according to claim 1, wherein
when the second axis direction is defined as a width direction, a width size of the first floating electrode is larger than a width size of the lead internal electrode.

5. The multilayer ceramic electronic component according to claim 1, wherein
the first floating electrode includes a pair of side edges extending along the third axis direction, and
at least one of the side edges is located outside the lead internal electrode along the second axis direction.

6. The multilayer ceramic electronic component according to claim 1, wherein
when the third axis direction is defined as a length direction, a length size of the first floating electrode is larger than a length size of the lead internal electrode.

7. The multilayer ceramic electronic component according to claim 1, wherein
an end portion of the first floating electrode in the third axis direction is located outward in the third axis direction relative to an end portion of the lead internal electrode in the third axis direction, the end portion being opposite to an end portion of the lead internal electrode connected to the first external electrode or the second external electrode.

8. The multilayer ceramic electronic component according to claim 1, wherein
the internal electrode includes a core material, and
the first boundary layer is formed on at least one side of the core material in a first axis direction.

9. The multilayer ceramic electronic component according to claim 1, wherein
when the first axial direction is defined as a thickness direction, a thickness size of the first floating electrode is smaller than a thickness size of the lead internal electrode.

10. The multilayer ceramic electronic component according to claim 1, wherein
the lead internal electrode includes
a third lead internal electrode led out to one side of the ceramic element in the third axis direction and connected to the first external electrode, and
a fourth lead internal electrode disposed to be shifted from the third lead internal electrode in the third axis direction, led out to another side of the ceramic element in the third axis direction, and connected to the second external electrode,
the internal electrode includes
a plurality of the first floating electrodes arranged along the third axis direction so as to be spaced apart from each other, and
a second floating electrode arranged between the third lead internal electrode and the fourth lead internal electrode along the third axis direction,
one of the plurality of the first floating electrodes faces the third lead internal electrode and the second floating electrode along the first axis direction via the dielectric layer, and
another of the plurality of the first floating electrodes faces the fourth lead internal electrode and the second floating electrode along the first axis direction via the dielectric layer.

11. The multilayer ceramic electronic component according to claim 10, wherein
the second floating electrode includes a second boundary layer formed between the first floating electrode and the second floating electrode and in contact with the dielectric layer, and
the second boundary layer includes at least one of Au, Pt, Ag, Fe, Sn, Ge, Hf, In, Si, V, or Y.

12. The multilayer ceramic electronic component according to claim 10, wherein
the internal electrode includes a core material, and
the second boundary layer is formed on at least one side of the core material in the first axis direction.

13. The multilayer ceramic electronic component according to claim 10, wherein
when the first axis direction is defined as a thickness direction, a thickness size of the second floating electrode is smaller than a thickness size of the lead internal electrode.
